(19) United States
(12) Patent Application Publication
(10) Pub. No.: US 2016/0111799 A1
(43) Pub. Date: Apr. 21, 2016

(54) Battery Terminal

(71) Applicant: Yazaki Corporation, Tokyo (JP)

(72) Inventors: Takayuki Kato, Susono-shi (JP); Takahiro Shiohama, Susono-shi (JP)

(73) Assignee: Yazaki Corporation, Tokyo (JP)

(21) Appl. No.: 14/978,563

(22) Filed: Dec. 22, 2015

Related U.S. Application Data
(63) Continuation of application No. PCT/JP2014/066586, filed on Jun. 23, 2014.

(30) Foreign Application Priority Data
Jun. 24, 2013 (JP) 2013-131624

(51) Int. Cl. H01R 4/30; H01M 2/30

(52) U.S. Cl. CPC H01R 4/30; H01M 2/30

(57) ABSTRACT

A battery terminal body includes a cylindrical fastening portion and a first grip portion. The cylindrical fastening portion has a fastening aperture, a first extension fastening portion and a second extension fastening portion. The first grip portion is connected to the first extension fastening portion and includes a first through hole. A second grip portion includes a second through hole overlapping with a part of the first through hole. An outer diameter of a tapered portion increases gradually from an outer diameter narrower than a region where the first through hole and the second through hole overlap with each other before insertion to an outer diameter wider than the overlapping region. When inserted into the first through hole and the second insertion hole, the tapered portion expands the overlapping region to thereby narrow the fastening aperture.

### CROSS REFERENCE TO RELATED APPLICATIONS

This application is a continuation of PCT application No. PCT/JP2014/066586, which was filed on Jun. 23, 2014 based on Japanese Patent Application (No. 2013-131624) filed on Jun. 24, 2013, the contents of which are incorporated herein by reference.

### BACKGROUND OF THE INVENTION

1. Field of the Invention

The present invention relates to a battery terminal used to connect an electric wire to a battery post mounted on a car or the like.

2. Description of the Related Art

In the background art, work for attaching a battery terminal to a battery post protruding from a battery is performed with a tool placed on the periphery of the battery post. In recent years, however, a large number of components are placed on the periphery of the battery post. There is a problem that it is therefore difficult to secure a space for placing the tool on the periphery of the battery post. To solve the problem, intensive researches have been made for a battery terminal that can be attached to a battery post without inserting any tool to the periphery of the battery post (for example, JP-B-4082561 and JP-B-3949207).

A battery terminal 101 according to JP-B-4082561 (Background-Art Example 1) includes a battery terminal body portion 124 and a fastening unit 125 as shown in FIG. 9. The battery terminal body portion 124 includes a battery post insertion hole 123 to which a battery post (not shown) can be inserted, a notch portion 131 in which the battery terminal body portion 124 has been notched between an outer edge 130 and the battery post insertion hole 123, and a second bolt insertion hole 132 that is formed on the opposite sides of the notch portion 131 in the battery terminal body portion 124.

The fastening unit 125 includes a bracket 134, a bolt 135 and a nut 136. The bracket 134 is formed into a belt-like shape, including a bracket body 137 having a bolt insertion hole 139 to which the bolt 135 can be inserted, and a pair of slope portions 138 that are provided erectly from opposite end portions of the bracket body 137 and inclined in directions leaving each other in accordance with the distance from the bracket body 137.

In the battery terminal 101 configured thus, the bracket body 137 approaches the upper surface of the battery terminal body portion 124 as the bolt 135 and the nut 136 are screwed down to each other. Thus, the inner surfaces of the slope portions 138 slide on outer edges 122 of the battery terminal body portion 124 on the opposite sides of the notch portion 131. Then the outer edges 122 are fastened to approach each other to thereby reduce the width of the notch portion 131 and reduce the diameter of the battery post insertion hole 123 so that the inner surface of the battery post insertion hole 123 and the external surface of the battery post can be brought into tight contact with each other. In this manner, in the battery terminal 101 according to JP-B-4082561, the operation of fastening the nut 136 from above is performed so that the battery terminal 101 can be attached to the battery post without providing an enough working space around the battery post.

A battery terminal 221 according to JP-B-3949207 (Background-Art Example 2) includes a fixation portion 223, a pair of fastening plates 225, a bolt 237, a nut 241, a washer 239 and a pair of spacers 243 as shown in FIG. 10. The fixation portion 223 has a cylindrical shape into which a battery electrode (not shown) can be inserted. In the fixation portion 223, a fastening aperture 231 is formed to divide the circumferential portion of the fixation portion 223 axially. The pair of fastening plates 225 are formed continuously to the opposite ends of the fixed 223 across the fastening aperture 231 so as to be opposed to each other through the fastening aperture 231. A long hole that is long in the axial direction of the fixation portion 223 is formed in each fastening plate 225. Each spacer 243 has a polygonal shape, and a through hole 245 the bolt 237 can penetrate is formed in the spacer 243.

In the battery terminal 221 configured thus, as shown in FIG. 10, the spacer 243, the pair of fastening plates 225, the spacer 243 and the washer 239 are aligned sequentially, and the bolt 237 is inserted to them. The front end of the bolt 237 is screwed down to the nut 241 to narrow the fastening aperture 231 of the fixation portion 223. Thus, the fixation portion 223 is fastened to the battery electrode. On this occasion, the spacer 243 on the side of a head portion 237a of the bolt 237 is inclined to be thickened gradually as it goes upward, while the spacer 243 on the side of the nut 241 is inclined to be thickened gradually as it goes downward. Therefore, the bolt 237 is inclined obliquely right upward with respect to the horizontal plane, so that the work for fastening the nut 241 can be performed from above. That is, also as for the battery terminal 221 according to JP-B-3949207, the battery terminal 221 can be attached to the battery electrode without providing an enough working space around the battery electrode.

However, in the battery terminal 101 disclosed in JP-B-4082561, as shown in FIG. 11, when the slope portions 138 slide on the outer edges 122 and begin to narrow the width of the notch portion 131, an end portion of each outer edge 122 on the notch portion 131 side is inclined largely to generate a gap between the outer edge 122 on the notch portion 131 side and corresponding one of the slope portions 138. Thus, of the inner surface of the slope portion 138 sliding on the outer edge 122, only a part is in contact with the outer edge 122. In such a state (the state shown in FIG. 11), stress generated when the width of the notch portion 131 is narrowed is applied to only the part of the slope portion 138 sliding in contact with the outer edge 122. Accordingly, an excessive force to expand the slope portion 138 acts on the part. Thus, a large burden is imposed on the continuous connection portion connecting the slope portion 138 continuously to the bracket body 137. In this manner, when the battery terminal 101 is attached to the battery post repeatedly, the continuous connection portion between the bracket body 137 and each slope portion 138 is fatigued to increase the angle of the slope portion 138 with respect to the bracket body 137. As a result, there arises a problem that, even if the slope portion 138 is brought into contact with the outer edge 122 so as to slide thereon, the width of the notch portion 131 cannot be narrowed satisfactorily, and it is difficult to attach the battery terminal 101 to the battery post.

On the other hand, also in JP-B-3949207, as shown in FIGS. 12A and 12B, when the nut 241 is screwed down to the bolt 237 to begin to narrow the fastening aperture 231 of the fixation portion 223, each fastening plate 225 is inclined largely on its open end portion side. Thus, stress caused by the bolt 237 and the nut 241 is applied to only a part of the fastening plate 225, and an excessive burden is imposed on the continuous connection portion between the fastening plate 225 and the fixation portion 223. As a result, also as for the battery terminal 221, there is a problem that it is difficult to attach the battery terminal 221 to the battery electrode repeatedly.

### SUMMARY OF THE INVENTION

The present invention has been developed in consideration of the aforementioned circumstances. An object of the invention is to provide a battery terminal that can be attached to a battery post repeatedly.

The aforementioned object of the invention is attained by the following configurations.

(1) A battery terminal including:

a battery terminal body; including:
a cylindrical fastening portion for inserting a battery post therein, which includes a fastening aperture dividing a circumferential portion of the cylindrical fastening portion radially, the cylindrical fastening portion including a first extension fastening portion and a second extension fastening portion, the first extension fastening portion extending circumferentially on one end side where the fastening aperture is formed, the second extension fastening portion extending circumferentially on the other end side where the fastening aperture is formed, the first extension fastening portion and the second extension fastening portion being disposed alternately;
a first grip portion that is connected continuously to the first extension fastening portion, the first grip portion including a first through hole that is formed to penetrate the first grip portion in an insertion direction of the battery post; and
a second grip portion that is connected continuously to the second extension fastening portion, the second grip portion including a second through hole that is formed to penetrate the second grip portion in the insertion direction of the battery post, the second through hole overlapping with a part of the first through hole when viewed in the insertion direction of the battery post; and

a fastening unit including a tapered portion whose outer diameter increases gradually from an outer diameter narrower than a region where the first through hole and the second through hole overlap with each other before insertion of the fastening unit to an outer diameter wider than the overlapping region when viewed in the insertion direction of the battery post,

wherein when the fastening unit is inserted into the first through hole and the second insertion hole, the overlapping region is expanded by the tapered portion so that the first extension fastening portion to which the first grip portion is continuously connected and the second extension fastening portion to which the second grip portion is continuously connected are be moved to cross each other to thereby narrow the fastening aperture of the cylindrical fastening portion, so that the battery post is fastened by an inner circumferential surface of the cylindrical fastening portion.

According to the invention having the aforementioned configuration (1), stress with which the battery terminal is fastened to the battery post is always received by the whole of the continuous connection portion between the first grip portion and the first extension fastening portion and the whole of the continuous connection portion between the second grip portion and the second extension fastening portion. Thus, the battery terminal can be attached to the battery post repeatedly.

(2) A battery terminal according to the aforementioned configuration (1), wherein the second extension fastening portion has a width as same as that of the first extension fastening portion and is located adjacently to the first extension fastening portion in the insertion direction of the battery post.

According to the invention having the aforementioned configuration (2), due to the configuration in which a force to move the first grip portion and the second grip portion by means of the fastening unit is applied to substantially the center in a height direction of the battery terminal body, so that the force can be applied to the cylindrical fastening portion with good balance in a left/right direction. In addition, when the first through hole and the second through hole are brought into pressure contact with each other by the fastening unit, a force in the insertion direction of the fastening unit is received by the first grip portion and the second grip portion together, so that the first grip portion and the second grip portion can be prevented from being bent in the insertion direction of the fastening unit.

(3) A battery terminal according to the aforementioned configuration (2), wherein the first grip portion includes a first plate grip portion and a first protrusion grip portion, the first plate grip portion having a plate-like shape and connected continuously to an external surface of a side end portion of the first extension fastening portion on the second extension fastening portion side so as to extend in a tangential direction of the first extension fastening portion, the first through hole being formed in the first plate grip portion, the first protrusion grip portion protruding from a longitudinal end portion of the first plate grip portion in a direction perpendicular to a longitudinal direction of the first plate grip portion so as to face a circumferential end portion of the first extension fastening portion; and

wherein the second grip portion includes a second plate grip portion and a second protrusion grip portion, the second plate grip portion having a plate-like shape and connected continuously to an external surface of a side end portion of the second extension fastening portion on the first extension fastening portion side so as to extend in a tangential direction of the second extension fastening portion, the second through hole being formed in the second plate grip portion, the second plate grip portion overlapping with a part of the first plate grip portion, the second protrusion grip portion protruding from a longitudinal end portion of the second plate grip portion in a direction perpendicular to a longitudinal direction of the second grip portion so as to face a circumferential end portion of the second extension fastening portion and the first protrusion grip portion.

According to the invention having the aforementioned configuration (3), the first extension fastening portion and the second extension fastening portion are moved in directions leaving each other by an action of picking up the first protrusion grip portion and the second protrusion grip portion, so as to expand the fastening aperture. Thus, the battery terminal can be removed from the battery post easily.

According to the invention, stress with which the battery terminal is fastened to the battery post is always received by the whole of the continuous connection portion between the first grip portion and the first extension fastening portion and the whole of the continuous connection portion between the second grip portion and the second extension fastening portion. Thus, the battery terminal can be attached to the battery post repeatedly.

### BRIEF DESCRIPTION OF THE DRAWINGS

FIG. 1 is a developed perspective view of a battery terminal according to a first embodiment.

FIG. 2 is a top view of a battery terminal body that has not been fastened yet in FIG. 1.

FIG. 3 is a front view of the battery terminal body that has not been fastened yet in FIG. 1.

FIG. 4 is a perspective view of the battery terminal that is being fastened according to the first embodiment.

FIG. 5 is a sectional view taken on line A-A in FIG. 4.

FIG. 6 is a top view of the battery terminal body that has been completely fastened.

FIG. 7 is a perspective view of a battery terminal that is being fastened according to a second embodiment.

FIG. 8 is a sectional view taken on line B-B in FIG. 7.

FIG. 9 is a developed perspective view of a battery terminal according to Background-Art Example 1.

FIG. 10 is a developed perspective view of a battery terminal according to Background-Art Example 2.

FIG. 11 is a top view showing the battery terminal in which fastening work has been started in Background-art Example 1.

FIG. 12A is a schematic top view showing a state in which the battery terminal has not been fastened to a battery electrode yet in Background-Art Example 2, and FIG. 12B is a schematic top view showing a state in which fastening work has been started at the state of FIG. 12A.

### DETAILED DESCRIPTION OF THE EXEMPLARY EMBODIMENTS

### First Embodiment

A battery terminal 1 according to a first embodiment of the invention will be described below with reference to the drawings.

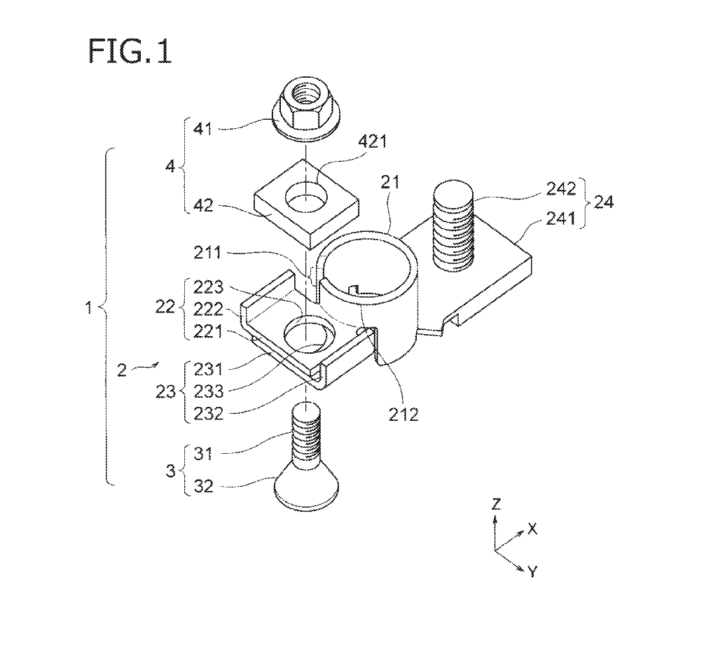

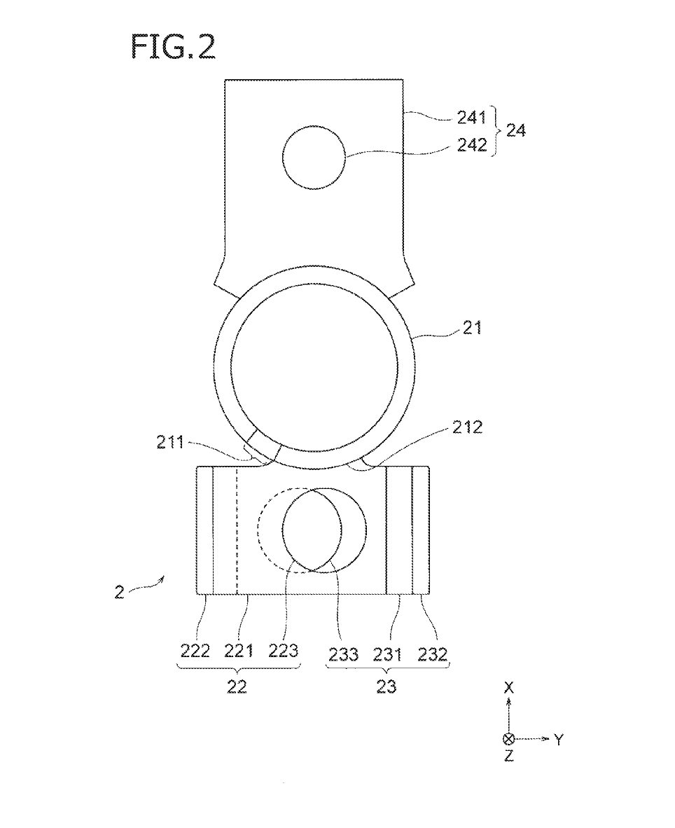

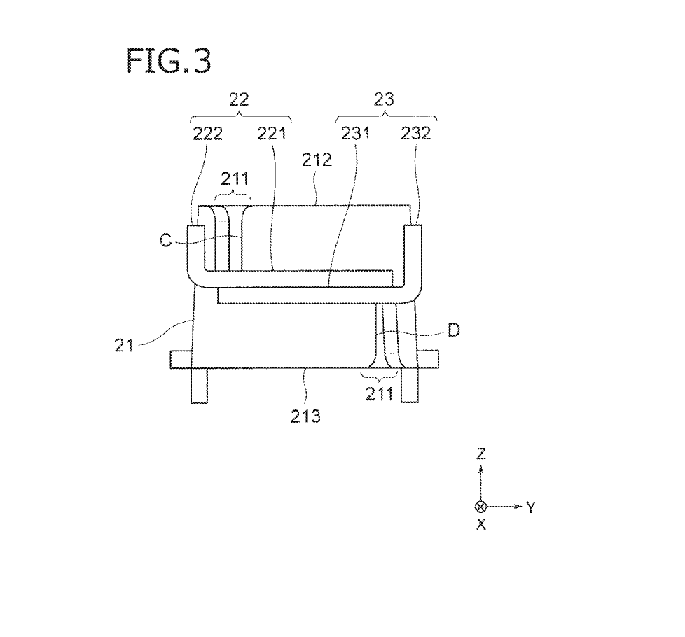

FIG. 1 is a developed perspective view of the battery terminal 1 according to the first embodiment. FIG. 2 is a top view of a battery terminal body 2 that has not been fastened yet in FIG. 1. FIG. 3 is a front view of the battery terminal body 2 that has not been fastened yet in FIG. 1.

Incidentally, regard the longitudinal direction of the battery terminal body 2 as x-axis, the width direction of the battery terminal body 2 as y-axis, and the height direction of the battery terminal body 2 as z-axis.

As shown in FIG. 1, the battery terminal 1 includes the battery terminal body 2 that can be attached to a battery post (not shown), a fastening insertion portion 3 (fastening unit) and a fastening screw portion 4. The battery post is an electrode provided to protrude on a battery (not shown) mounted in a car or the like. Lead is chiefly used as a raw material of the battery post. The battery post is a truncated cone with a tapered shape whose diameter decreases gradually as it goes toward its upper end.

The battery terminal body 2 is, for example, made of a metal plate with conductivity. As shown in FIG. 1, the battery terminal body 2 includes a cylindrical fastening portion 21, a first grip portion 22 and a second grip portion 23 connected continuously to the external surface of the cylindrical fastening portion 21, and an electric connection portion 24 connected continuously to the external surface of the cylindrical fastening portion 21 on the opposite side to the first grip portion 22 and the second grip portion 23.

As shown in FIG. 1 to FIG. 3, the cylindrical fastening portion 21 has a cylindrical shape to which the battery post can be inserted. A fastening aperture 211 is formed to bend radially like a hook in a circumferential portion of the cylindrical fastening portion 21 so as to divide the circumferential portion. The cylindrical fastening portion 21 includes a first extension fastening portion 212 and a second extension fastening portion 213. The first extension fastening portion 212 is formed on one divided end side (C side in FIG. 3) so as to extend circumferentially. The second extension fastening portion 213 is formed on the other divided end (D side in FIG. 3) so as to extend circumferentially and alternately with the first extension fastening portion 212.

As shown in FIG. 1 and FIG. 3, the first grip portion 22 has an L-shape in y-z sectional view, and includes a first plate grip portion 221 and a first protrusion grip portion 222. The first plate grip portion 221 has a plate-like shape connected continuously to the external surface of the first extension fastening portion 212 so as to extend in a tangential direction (the negative direction of the y-axis) of the first extension fastening portion 212. The first plate grip portion 221 has a first through hole 223 formed to penetrate the first plate grip portion 221 in the insertion direction of the battery post (z-axis direction). The first protrusion grip portion 222 is formed in a longitudinal end portion of the first plate grip portion 221 so as to protrude in a direction perpendicular to the longitudinal direction of the first plate grip portion 221. The first protrusion grip portion 222 is located to face a circumferential end portion (the end portion on the C side in FIG. 3) of the first extension fastening portion 212.

As shown in FIG. 1 and FIG. 3, the second grip portion 23 has an L-shape in y-z sectional view, and includes a second plate grip portion 231 and a second protrusion grip portion 232. The second plate grip portion 231 has a plate-like shape connected continuously to the external surface of the second extension fastening portion 213 so as to extend in a tangential direction (the positive direction of the y-axis) of the second extension fastening portion 213. The second plate grip portion 231 has a second through hole 233 formed to penetrate the second plate grip portion 231 in the insertion direction of the battery post. When viewed in the insertion direction of the battery post (x-y plane view), the second plate grip portion 231 overlaps with the first plate grip portion 221, and the second through hole 233 overlaps with a part of the first through hole 223. The second protrusion grip portion 232 is formed in a longitudinal end portion of the second plate grip portion 231 so as to protrude in a direction (the positive direction of the z-axis) perpendicular to the longitudinal direction of the second plate grip portion 231. The second protrusion grip portion 232 is located to face a circumferential end portion (the end portion on the D side in FIG. 3) of the second extension fastening portion 213 and the first protrusion grip portion 222.

Incidentally, as shown in FIGS. 1 and 3, the first through hole 223 and the second through hole 233 are, for example, formed as circular holes.

Here, the region where the first through hole 223 and the second through hole 233 overlap with each other is a region formed out of the inner circumferential surface on the first protrusion grip portion 222 side in the first through hole 223 (the inner circumferential surface of the first through hole 223 on the circumferential end side of the first extension fastening portion 212) and the inner circumferential surface on the second protrusion grip portion 232 side in the second through hole 233 (the inner circumferential surface of the second through hole 233 on the circumferential end side of the second extension fastening portion 213) when viewed in the insertion direction of the battery post. The region where the first through hole 223 and the second through hole 233 overlap with each other is formed thus so that, when the fastening insertion portion 3, which will be described later, is inserted into the first through hole 223, the inner circumferential surface on the first protrusion grip portion 222 side in the first through hole 223 can be pressed by a tapered portion 32, which will be described later, to thereby move the first grip portion 22 to left (in the negative direction of the y-axis) and move the first extension fastening portion 212 in a direction narrowing the fastening aperture 211. In the same manner, when the fastening insertion portion 3, which will be described later, is inserted into the second through hole 233, the inner circumferential surface on the second protrusion grip portion 232 side in the second through hole 233 can be pressed by the tapered portion 32 to thereby move the second grip portion 23 to right (in the positive direction of the y-axis) and move the second extension fastening portion 213 in a direction narrowing the fastening aperture 211.

In this manner, the battery terminal 1 according to the embodiment converts the insertion operation of the fastening insertion portion 3, which will be described later, in the up/down direction (the z-axis direction) into an operation of the first extension fastening portion 212 and the second extension fastening portion 213 in the left/right direction (the y-axis direction) so that the battery post can be fastened by the inner circumferential surface of the cylindrical fastening portion 21.

In addition, the second extension fastening portion 213 may have the same width (length in the z-axis direction) as the first extension fastening portion 212, and be located adjacent to the first extension fastening portion 212 in the insertion direction of the battery post. In this case, the first grip portion 22 may be formed to be connected continuously to the external surface of the first extension fastening portion 212 in its side end portion on the second extension fastening portion 213 side while the second grip portion 23 is formed to be connected continuously to the external surface of the second extension fastening portion 213 in its side end portion on the first extension fastening portion 212 side.

Due to this configuration, the region where the first grip portion 22 and the first extension fastening portion 212 are connected continuously to each other and the region where the second grip portion 23 and the second extension fastening portion 213 are connected continuously to each other can be formed substantially at the center in the height direction (the z-axis direction) of the battery terminal body 2. Accordingly, stress can be transmitted to the cylindrical fastening portion 21 in well balance in the left/right direction so as to narrow the fastening aperture 211 when the first grip portion 22 and the second grip portion 23 are moved in the left/right direction (the y-axis direction).

In addition, due to the configuration, the first grip portion 22 and the second grip portion 23 are positioned to overlap with each other in the insertion direction of the battery post (the z-axis direction) so that a force applied when the fastening insertion portion 3, which will be described later, is inserted into the first through hole 223 and the second through hole 233 can be received by the first grip portion 22 and the second grip portion 23 together. Accordingly, the first grip portion 22 and the second grip portion 23 can be prevented from being bent in the z-axis direction.

As shown in FIG. 1, the electric connection portion 24 includes a flat portion 241 extending horizontally (in the x-y plane direction) from the cylindrical fastening portion 21, and a stud bolt 242 provided erectly upward (in the positive direction of the z-axis) from the flat portion 241. An LA terminal (not shown) fixed to a cable terminal to which a fusible link, a starter or the like is connected is attached to the stud bolt 242.

As shown in FIG. 1 and FIG. 3, the fastening insertion portion 3 is to be inserted into the first through hole 223 and the second through hole 233. The fastening insertion portion 3 includes a straight portion 31 and the tapered portion 32. The straight portion 31 has a columnar shape whose outer diameter is narrower than the region where the first through hole 223 and the second through hole 233 overlap with each other before the insertion when viewed in the insertion direction of the battery post. A threaded groove is formed in the outer circumference of the straight portion 31. The tapered portion 32 is formed so that the outer diameter of the tapered portion 32 can increase gradually from an outer diameter as large as that of the columnar shape (an outer diameter narrower than the region where the first through hole 223 and the second through hole 233 overlap with each other before the insertion) to an outer diameter wider than the region where the first through hole 223 and the second through hole 233 overlap with each other before the insertion, as it goes downward (in the negative direction of the z-axis).

As shown in FIG. 1, the fastening screw portion 4 is to be screwed down to the front end of the fastening insertion portion 3 inserted into the first through hole 223 and the second through hole 233. The fastening screw portion 4 includes a nut portion 41 and a pressure plate portion 42. A threaded groove is formed in the inner circumferential surface of the nut portion 41 so that the nut portion 41 can be screwed down to the straight portion 31. The pressure plate portion 42 has a plate-like shape wider than the first through hole 223 and the second through hole 233. An insertion portion through hole 421 is formed in the pressure plate portion 42 and in the insertion direction to the battery post. The pressure plate portion 42 is placed on the upper surface of the first plate grip portion 221 so that the insertion portion through hole 421 can overlap with the first through hole 223 and the second through hole 233 when viewed in the insertion direction to the battery post.

Since the battery terminal 1 according to the embodiment is configured thus, the first through hole 223 and the second through hole 233 are pressed by the tapered portion 32 when the nut portion 41 is screwed down from the front end of the straight portion 31 after the fastening insertion portion 3 is inserted into the second through hole 233, the first through hole 223 and the insertion portion through hole 421 sequentially. Thus, the region where the first through hole 223 and the second through hole 233 overlap with each other is expanded. Then, in the battery terminal 1 according to the embodiment, the region where the first through hole 223 and the second through hole 233 overlap with each other is expanded gradually by the tapered portion 32 so that the first extension fastening portion 212 the first grip portion 22 is connected continuously to and the second extension fastening portion 213 the second grip portion 23 is connected continuously to can be moved to cross each other. When the first extension fastening portion 212 and the second extension fastening portion 213 move to cross each other, the fastening aperture 211 of the cylindrical fastening portion 21 is narrowed so that the battery terminal 1 can be fastened to the battery post. In this manner, in the battery terminal 1 according to the embodiment, the battery terminal 1 can be attached to the battery post by such a simple operation that the fastening insertion portion 3 is inserted into the second through hole 233, the first through hole 223 and the insertion portion through hole 421 sequentially and the nut portion 41 is screwed down.

In addition, in the battery terminal 1 according to the embodiment, the first plate grip portion 221 having the first through hole 223 and the second plate grip portion 231 having the second through hole 233 are formed continuously to the external surface of the first extension fastening portion 212 and the external surface of the second extension fastening portion 213 so that stress required for narrowing the fastening aperture 211 of the cylindrical fastening portion 21 can be always received by the wide area including the continuous connection region between the first plate grip portion 221 and the first extension fastening portion 212 and the continuous connection region between the second plate grip portion 231 and the second extension fastening portion 213.

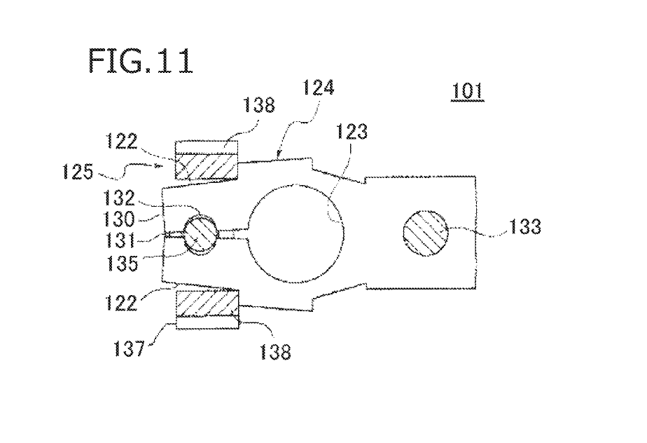

In addition, in the battery terminal 1 according to the embodiment, the first plate grip portion 221 and the second plate grip portion 231 moved by the tapered portion 32 of the fastening insertion portion 3 are formed to be connected continuously to the external surface of the first extension fastening portion 212 and the external surface of the second extension fastening portion 213 respectively so that the first plate grip portion 221 and the second plate grip portion 231 can always move together with the first extension fastening portion 212 and the second extension fastening portion 213 respectively to thereby narrow the fastening aperture 211 of the cylindrical fastening portion 21. Thus, the battery post can be fastened by the inner circumferential surface of the cylindrical fastening portion 21. That is, in the battery terminal 1 according to the embodiment, differently from the state of FIG. 11 shown in Background-Art Example 2, there occurs no gap in the continuous connection region between the first plate grip portion 221 and the first extension fastening portion 212 or the continuous connection region between the second plate grip portion 231 and the second extension fastening portion 213 when the battery terminal 1 is fastened to the battery post. Thus, there is no fear that excessive stress is applied to only a part of those continuous connection regions. It is therefore possible to prevent the continuous connection regions from being fatigued.

In this manner, no excessive fatigue occurs in the continuous connection region between the first plate grip portion 221 and the first extension fastening portion 212 or the continuous connection region between the second plate grip portion 231 and the second extension fastening portion 213 even when the battery terminal 1 according to the embodiment is attached to the battery post repeatedly. Accordingly, the moving amounts of the first plate grip portion 221 and the second plate grip portion 231 moved by the tapered portion 32 can be transmitted to the first extension fastening portion 212 and the second extension fastening portion 213 surely to attach the battery terminal 1 to the battery post.

In this manner, the battery terminal 1 according to the embodiment can be attached to the battery post repeatedly.

Next, description will be made about work for attaching the battery terminal 1 according to the embodiment to the battery post and work for removing the battery terminal 1 from the battery post.

First, the work for attaching the battery terminal 1 to the battery post will be described. In a state before the work, assume that an LA terminal (not shown) has been attached to the stud bolt 242.

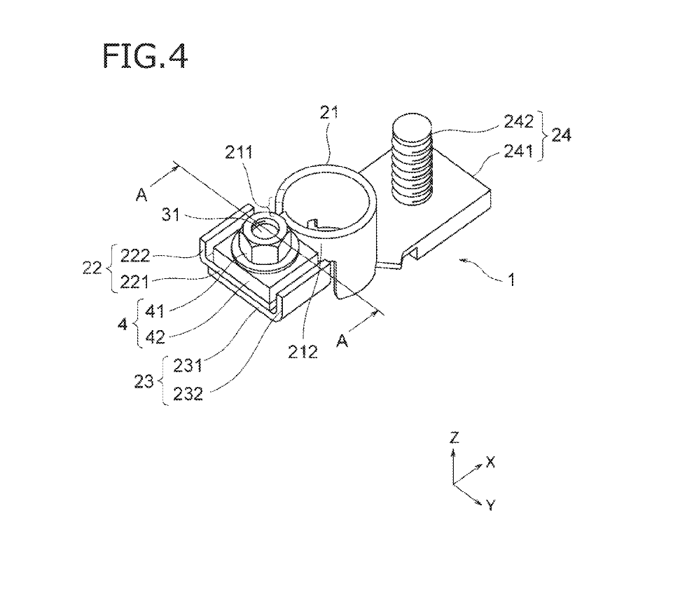

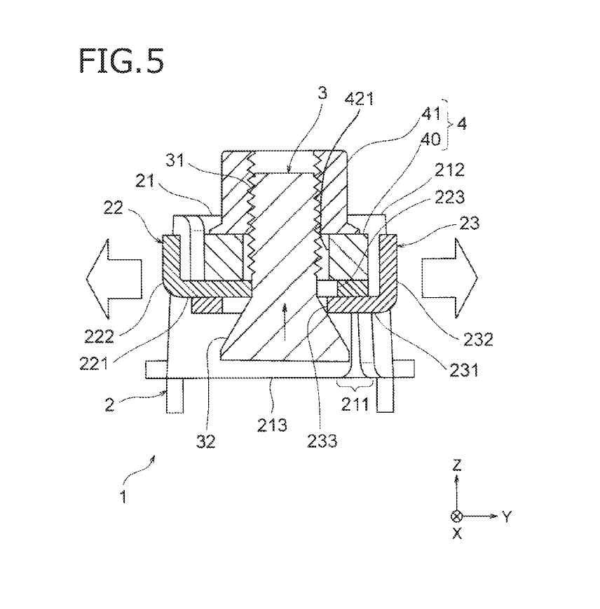

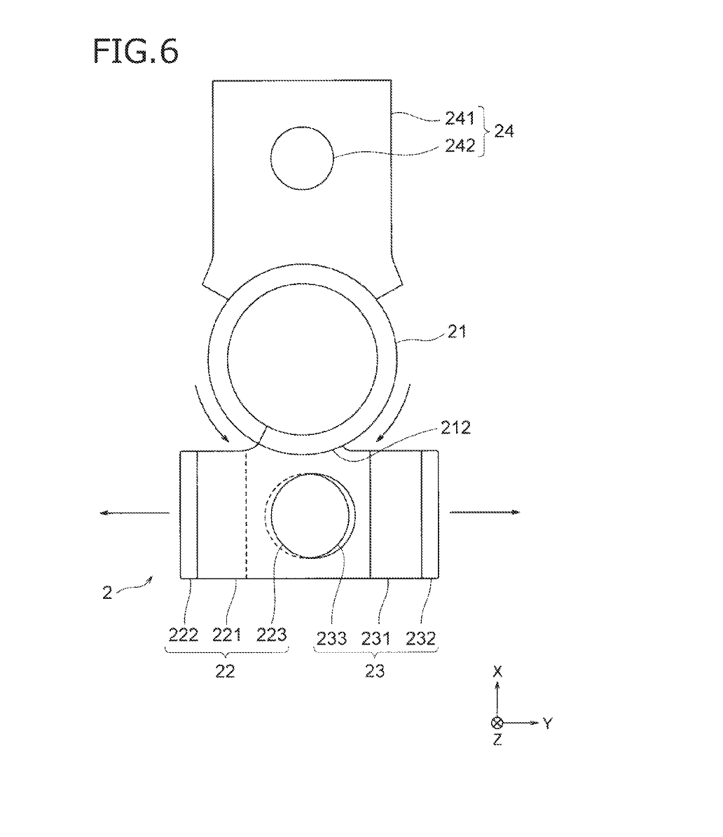

FIG. 4 is a perspective view of the battery terminal 1 that is being fastened according to the first embodiment. FIG. 5 is a sectional view taken on line A-A in FIG. 4. FIG. 6 is a top view of the battery terminal body 2 that has been completely fastened.

A worker places the pressure plate portion 42 on the upper surface of the battery terminal body 2 shown in FIG. 2, which has not been fastened yet. The worker inserts the fastening insertion portion 3 into the second through hole 233, the first through hole 223 and the insertion portion through hole 421 from below the second plate grip portion 231 with the straight portion 31 foremost, and slightly screws the front end of the fastening insertion portion 3 with the nut portion 41. In this state, the straight portion 31 is located inside the first through hole 223 and the second through hole 233. Therefore, there is no fear that particularly the first through hole 223 and the second through hole 233 are pressed by the tapered portion 32. That is, in this stage, the battery terminal body 2 is in the same state as the state shown in FIG. 2 where the battery terminal body 2 has not been fastened yet.

The worker picks up the first protrusion grip portion 222 and the second protrusion grip portion 232 from their opposite sides and moves the first extension fastening portion 212 and the second extension fastening portion 213 away from each other to thereby expand the fastening aperture 211. Then the worker attaches the battery terminal 1 to the battery post. The worker rotates the nut portion 41 to advance screwing of the fastening insertion portion 3 down to the nut portion 41 and thereby move the fastening insertion portion 3 upward. When the fastening insertion portion 3 moves upward thus, as shown in FIGS. 4 and 5, the tapered portion 32 presses the inner circumferential surface of the second through hole 233 on the second protrusion grip portion 232 side to thereby move the second plate grip portion 231 to right (in the positive direction of the y-axis) together with the second through hole 233. Thus, the region where the first through hole 223 and the second through hole 233 overlap with each other is expanded. When the worker further rotates the nut portion 41 to thereby advance screwing of the fastening insertion portion 3 down to the nut portion 41, the tapered portion 32 presses the inner circumferential surface on the first protrusion grip portion 222 side to thereby move the first plate grip portion 221 to left (in the negative direction of the y-axis) together with the first through hole 223. Thus, the region where the first through hole 223 and the second through overlap with each other is further expanded.

The worker rotates the nut portion 41 until the battery terminal body 2 is brought into the state shown in FIG. 6 and the lower end portion of the tapered portion 32 abuts against the outer circumferential surface of the second through hole 233. Then the worker terminates the work for attaching the battery terminal 1.

In this manner, the first plate grip portion 221 is moved to left and the second plate grip portion 231 is moved to right so as to move the first extension fastening portion 212 connected continuously to the external surface of the first plate grip portion 221 and the second extension fastening portion 213 connected continuously to the external surface of the second plate grip portion 231 to thereby narrow the fastening aperture 211 of the cylindrical fastening portion 21. Thus, the battery post can be fastened satisfactorily by the inner circumferential surface of the cylindrical fastening portion 21.

That is, in the battery terminal 1 according to the embodiment, the battery terminal body 2 is changed from the state of FIG. 2 to the state of FIG. 6 (the region where the first through hole 223 and the second through hole 233 overlap with each other after the fastening is made wider than the region where the first through hole 223 and the second through hole 233 overlap with each other before the fastening), so that the first extension fastening portion 212 and the second extension fastening portion 213 can be moved to cross each other to thereby narrow the fastening aperture 211 of the cylindrical fastening portion 21. Thus, the battery terminal 1 can be fixed to the battery post.

In addition, in the battery terminal 1 according to the embodiment, the work for attaching the nut portion 41 is performed from above the battery terminal body 2. Accordingly, the battery terminal 1 can be attached to the battery post surely even in the state where a large number of components have been placed around the battery post. Thus, the battery terminal 1 according to the embodiment can be attached to the battery post even in the state where there is no space for inserting a tool or the like around the battery post.

Next, the work for removing the battery terminal 1 according to the embodiment from the battery post will be described. Assume that the state before the work is a state where the battery terminal 1 has been attached to the battery post by the aforementioned work.

The worker rotates the nut portion 41 in a direction to loosen the nut portion 41 so that the fastening insertion portion 3 can be moved downward to thereby gradually loosen the state where the inner circumferential surface of the first through hole 223 and the inner circumferential surface of the second through hole 233 have been pressed by the tapered portion 32. When the straight portion 31 is located inside the first through hole 223 and the second through hole 233, the battery terminal body 2 returns to the state of FIG. 2. Then the worker picks up the first protrusion grip portion 222 and the second protrusion grip portion 232 so as to move the first extension fastening portion 212 and the second extension fastening portion 213 away from each other to thereby widen the fastening aperture 211 of the cylindrical fastening portion 21. Then the battery terminal 1 is removed from the battery post.

The worker further rotates the nut portion 41 in a direction to loosen the nut portion 41 and removes the nut portion 41 and the pressure plate portion 42 from the fastening insertion portion 3. Then the worker also removes the fastening insertion portion 3 from the first through hole 223 and the second through hole 233. Thus, the work for removing the battery terminal 1 is terminated.

In this manner, the worker can remove the battery terminal 1 according to the embodiment by such a simple work that the nut portion 41 is loosened and the first protrusion grip portion 222 and the second protrusion grip portion 232 are picked up.

In the battery terminal 1 according to the embodiment, whether the battery terminal 1 is attached to the battery post or removed from the battery post, the whole of the first extension fastening portion 212 and the whole of the second extension fastening portion 213 are moved in directions to cross each other or in directions to leave each other. Thus, stress generated when the battery terminal 1 is fastened to the battery post can be received by the whole of the first extension fastening portion 212 and the whole of the second extension fastening portion 213.

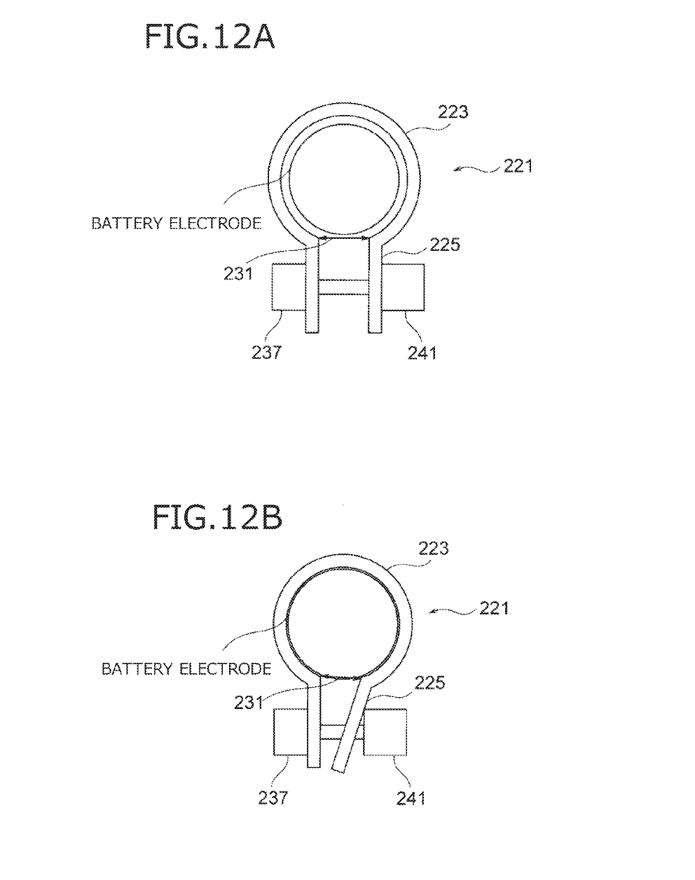

That is, in the battery terminal 1 according to the embodiment, differently from FIG. 12B shown in Background-Art Example 2, there is no case that stress generated when the battery terminal 1 is fastened to the battery post is received by only a part of the cylindrical fastening portion 21. For example, in Background-Art Example 2, excessive burden is applied to a part of each fastening plate 225 during the fastening work after the bolt 237 and the nut 241 are removed. As a result, the angle of the fastening plate 225 with the fixation portion 223 is changed so that the fastening aperture 231 formed by the pair of fastening plates 225 cannot return to its original distance. Thus, there arises a problem that it is difficult to remove the battery terminal 221 from the battery electrode. On the other hand, in the battery terminal 1 according to the embodiment, there is no case that such a problem occurs. That is, in the battery terminal 1 according to the embodiment, the fastening aperture 211 of the cylindrical fastening portion 21 can return to its original distance after the battery terminal 1 fastened to the battery post is removed. Thus, the battery terminal 1 can be easily removed from the battery post.

Further, in the battery terminal 1 according to the embodiment, the first extension fastening portion 212 and the second extension fastening portion 213 can be separated from each other to thereby expand the fastening aperture 211 of the cylindrical fastening portion 21 by a simple work of picking up the first protrusion grip portion 222 and the second protrusion grip portion 232 opposed to each other. That is, in the battery terminal 1 according to the embodiment, the inner surface of the cylindrical fastening portion 21 can be separated from the battery post only by the picking-up work with a single hand. Thus, the battery terminal 1 can be removed from the battery post.

### Second Embodiment

A battery terminal 1 according to a second embodiment is different from the battery terminal 1 according to the first embodiment as to only the configurations of the fastening insertion portion 3 and the fastening screw portion 4. Therefore, only the configurations of a fastening insertion portion 3′ and a fastening screw portion 4′ will be described. Description of the other configurations will be omitted because they are the same as those in the first embodiment.

Incidentally, assume that the coordinate system is the same as that in the first embodiment.

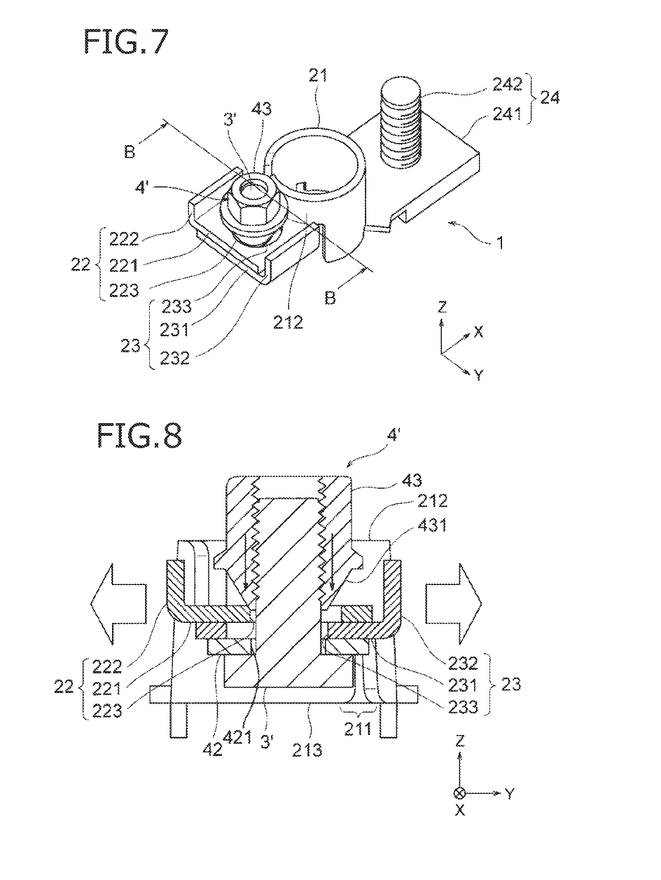

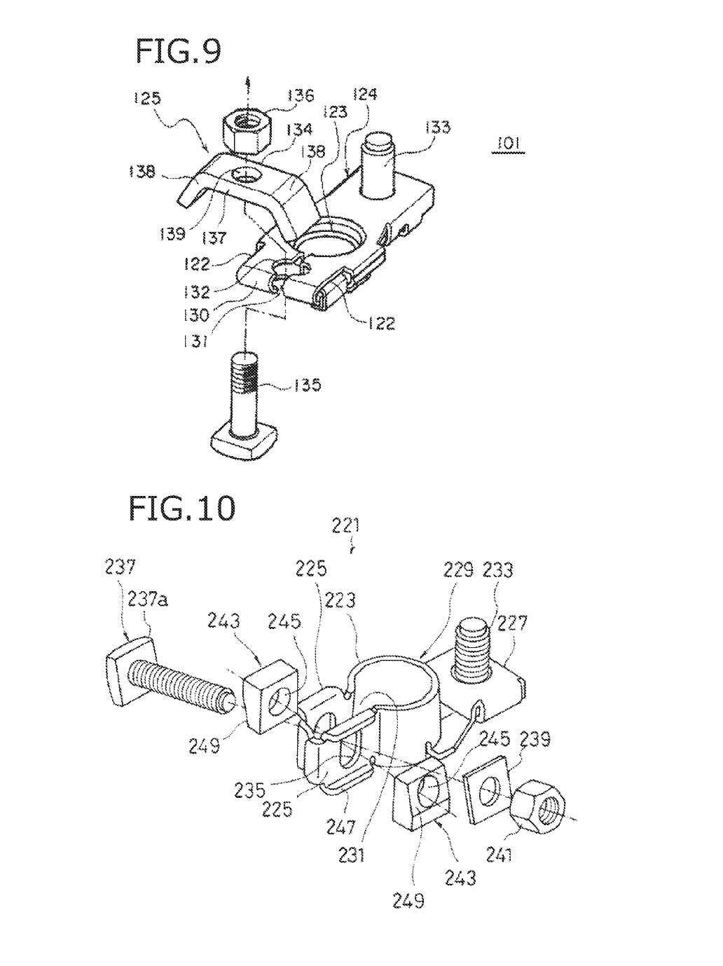

FIG. 7 is a perspective view of the battery terminal 1 that is being fastened according to the second embodiment. FIG. 8 is a sectional view taken on line B-B in FIG. 7.

As shown in FIG. 7 and FIG. 8, the fastening insertion portion 3′ is a well-known bolt having a threaded groove formed at its one end. The fastening screw portion 4′ (fastening unit) includes a tapered nut portion 43 and a pressure plate portion 42. The tapered nut portion 43 has a cylindrical shape. A threaded groove is formed in the inner circumferential surface of the tapered nut portion 43 so that the tapered nut portion 43 can be screwed down to the fastening insertion portion 3′. A tapered portion 431 is formed in an end portion of the tapered nut portion 43 on the fastening insertion portion 3′ side. When viewed in the insertion direction of the battery post, the outer diameter of the tapered portion 431 increases gradually from an outer diameter narrower than the region where the first through hole 223 and the second through hole 233 overlap with each other before the insertion to an outer diameter wider than the region where the first through hole 223 and the second through hole 233 overlap with each other before the insertion, as it goes downward (in the positive direction of the z-axis).

Incidentally, the pressure plate portion 42 is the same as that in the first embodiment. Therefore, description of the pressure plate portion 42 will be omitted.

Next, description will be made about the work for attaching the battery terminal 1 according to the second embodiment to the battery post. Assume that the state before the work is the same as the state described in the first embodiment.

Incidentally, the work for removing the battery terminal 1 according to the second embodiment from the battery post is substantially the same as that in the first embodiment. Therefore, description of the work will be omitted.

The worker disposes the pressure plate portion 42 on the lower surface of the second plate grip portion 231 so that the insertion portion through hole 421 can overlap with the second through hole 233 and the first through hole 223 when viewed in the insertion direction of the fastening insertion portion 3′. The worker inserts the fastening insertion portion 3′ into the pressure plate portion 42, the second through hole 233 and the first through hole 223 sequentially so that the end portion of the fastening insertion portion 3′ where the threaded groove is formed is foremost. The worker screws the tapered nut portion 43 slightly down to the front end of the fastening insertion portion 3′ inserted thus.

The worker attaches the battery terminal 1 in this state to the battery post, and rotates the tapered nut portion 43. With the advance of the rotation of the tapered nut portion 43, the tapered nut portion 43 moves downward (in the negative direction of the z-axis). Thus, as shown in FIG. 7 and FIG. 8, the inner circumferential surface of the first through hole 223 on the first protrusion grip portion 222 side is pressed by the tapered portion 431 to thereby move the first grip portion 22 to left (in the negative direction of the y-axis) and expand the region where the first through hole 223 and the second through hole 233 overlap with each other. When the tapered nut portion 43 moves further downward, the inner circumferential surface of the second through hole 233 on the second protrusion grip portion 232 side is pressed by the tapered portion 431 to thereby move the second grip portion 23 to right (in the positive direction of the y-axis) and expand the region where the first through hole 223 and the second through hole 233 overlap with each other. Then the worker rotates the tapered nut portion 43 until the front end of the tapered nut portion 43 abuts against the pressure plate portion 42. Thus the work for attaching the battery terminal 1 is terminated.

In this manner, the region where the first through hole 223 and the second through hole 233 overlap with each other is expanded by the tapered portion 431 so that the first extension fastening portion 212 and the second extension fastening portion 213 can be moved to cross each other. Thus, the fastening aperture 211 of the cylindrical fastening portion 21 can be narrowed so that the battery post can be fastened satisfactorily by the inner circumferential surface of the cylindrical fastening portion 21. That is, also in the battery terminal 1 according to the second embodiment, the battery post can be fastened and fixed satisfactorily in the same manner as in the battery terminal 1 according to the first embodiment. In addition, the battery terminal 1 according to the second embodiment can be also attached to the battery post repeatedly in the same manner as the battery terminal 1 according to the first embodiment.

In the second embodiment, differently from the first embodiment, an ordinary bolt is used as the fastening insertion portion 3′. It is therefore unnecessary to use a specially ordered component as the fastening insertion portion 3′, but it is possible to reduce the cost for manufacturing the battery terminal 1.

### Other Embodiments

Although the first embodiment and the second embodiment have been described on the assumption that the first through hole 223 and the second through hole 233 are circular holes, they are not limited thereto especially. The first through hole 223 and the second through hole 233 are not limited thereto especially as long as they are through holes having inner circumferential surfaces that can be pressed by the insertion operation of the fastening insertion portion 3 or 3′. For example, the first through hole 223 and the second through hole 233 may be formed as through holes that are rectangular or polygonal in sectional view (x-y sectional view).

In addition, although the first embodiment and the second embodiment have been described on the assumption that the first grip portion 22 includes the first plate grip portion 221 and the first protrusion grip portion 222 and the second grip portion 23 includes the second plate grip portion 231 and the second protrusion grip portion 232, they are not limited thereto. A configuration in which the first grip portion 22 includes only the first plate grip portion 221 and the second grip portion 23 includes only the second plate grip portion 231 may be used. Thus, the configurations of the first grip portion 22 and the second grip portion 23 can be simplified so that the cost for manufacturing the battery terminal 1 can be reduced.

In addition, although the first embodiment and the second embodiment have been described on the assumption that the first plate grip portion 221 is connected continuously to the external surface of the side end portion of the first extension fastening portion 212 on the second extension fastening portion 213 side and the second plate grip portion 231 is connected continuously to the external surface of the side end portion of the second extension fastening portion 213 on the first extension fastening portion 212 side, they are not limited thereto especially. Any configuration may be used as long as the first plate grip portion 221 is connected continuously to the external surface of the first extension fastening portion 212 and the second plate grip portion 231 is connected continuously to the external surface of the second extension fastening portion 213 so that a part of the first through hole 223 formed in the first plate grip portion 221 can overlap with a part of the second through hole 233 formed in the second plate grip portion 231 when viewed in the insertion direction of the battery post (in the x-y plane view).

Further, although the first embodiment and the second embodiment have been described on the assumption that the fastening aperture 211 of the cylindrical fastening portion 21 is formed to bend radially like a hook in the circumferential portion of the cylindrical fastening portion 21 so as to divide the circumferential portion, it is not limited thereto especially. It will go well only if the fastening aperture 211 divides the circumferential portion radially so that the fastening aperture 211 can move in a direction to reduce or expand the diameter of the cylindrical fastening portion 21.

The invention can be carried out in other various forms without departing from the spirit or main features of the invention. Therefore, the aforementioned embodiments are merely exemplary in all respects, but they must not be interpreted in an attributive manner. The scope of the invention is not bound to any sentence of the present description but is shown by the scope of claims. Further, all of modifications, various improvements, alternatives and changes belonging to the range of equivalency to the scope of claims are embraced within the scope of the invention.

Here, the features of the aforementioned embodiments of the battery terminals according to the invention will be summarized and listed briefly in the following paragraphs [1] to [3] respectively.

[1] A battery terminal (1) including:

a battery terminal body (2) including:
a cylindrical fastening portion (21) for inserting a battery post therein and which includes a fastening aperture (211) dividing a circumferential portion of the cylindrical fastening portion (21) radially, the cylindrical fastening portion (21) including a first extension fastening portion (212) and a second extension fastening portion (213), the first extension fastening portion (212) extending circumferentially on one end side where the fastening aperture (211) is formed, the second extension fastening portion (213) extending circumferentially on the other end side where the fastening aperture (211) is formed, the first extension fastening portion (212) and the second extension fastening portion (213) being disposed alternately;
a first grip portion (22) that is connected continuously to the first extension fastening portion (212), the first grip portion (22) including a first through hole (223) that is formed to penetrate the first grip portion (22) in an insertion direction of the battery post; and
a second grip portion (23) that is connected continuously to the second extension fastening portion (213), the second grip portion (23) including a second through hole (233) that is formed to penetrate the second grip portion (23) in the insertion direction of the battery post, the second through hole (233) overlapping with a part of the first through hole (223) when viewed in the insertion direction of the battery post; and

a fastening unit (3) including a tapered portion (32) whose outer diameter increases gradually from an outer diameter narrower than a region where the first through hole (223) and the second through hole (233) overlap with each other before insertion of the fastening unit (3) to an outer diameter wider than the overlapping region when viewed in the insertion direction of the battery post,

wherein when the fastening unit (3) is inserted into the first through hole (223) and the second insertion hole (233), the overlapping region is expanded by the tapered portion (32) so that the first extension fastening portion (212) to which the first grip portion (22) is continuously connected and the second extension fastening portion (213) to which the second grip portion (23) is continuously connected are moved to cross each other to thereby narrow the fastening aperture (211) of the cylindrical fastening portion (21), so that the battery post is fastened by an inner circumferential surface of the cylindrical fastening portion (21).

[2] The battery terminal (1) according to the aforementioned paragraph [1], wherein the second extension fastening portion (213) has a width as same as that of the first extension fastening portion (212) and is located adjacently to the first extension fastening portion (212) in the insertion direction of the battery post.
[3] The battery terminal according to the aforementioned paragraph [2], wherein the first grip portion (22) includes a first plate grip portion (221) and a first protrusion grip portion (222), the first plate grip portion (221) having a plate-like shape and connected continuously to an external surface of a side end portion of the first extension fastening portion (212) on the second extension fastening portion (213) side so as to extend in a tangential direction of the first extension fastening portion (212), the first through hole (223) being formed in the first plate grip portion (221), the first protrusion grip portion (222) protruding from a longitudinal end portion of the first plate grip portion (221) in a direction perpendicular to a longitudinal direction of the first plate grip portion (221) so as to face a circumferential end portion of the first extension fastening portion (212); and

wherein the second grip portion (23) includes a second plate grip portion (231) and a second protrusion grip portion (232), the second plate grip portion (231) having a plate-like shape and connected continuously to an external surface of a side end portion of the second extension fastening portion (213) on the first extension fastening portion (212) side so as to extend in a tangential direction of the second extension fastening portion (213), the second through hole (233) being formed in the second plate grip portion (231), the second plate grip portion (231) overlapping with a part of the first plate grip portion (221), the second protrusion grip portion (232) protruding from a longitudinal end portion of the second plate grip portion (231) in a direction perpendicular to a longitudinal direction of the second plate grip portion (231) so as to face a circumferential end portion of the second extension fastening portion (213) and the first protrusion grip portion (222).

Although the invention has been described in detail and with reference to its specific embodiments, it is obvious for those skilled in the art that various changes or modifications can be applied to the invention without departing from the spirit and scope thereof.

According to the invention, stress with which a battery terminal is fastened to a battery post is always received by the whole of a continuous connection portion between a first grip portion and a first extension fastening portion and the whole of a continuous connection portion between a second grip portion and a second extension fastening portion. Thus, there is an advantage that the battery terminal can be attached to the battery post repeatedly. The invention having the advantage is useful for a battery terminal used for electrically connecting an electric wire to a batter post mounted in a car or the like.

What is claimed is:

1. A battery terminal comprising:
a battery terminal body; comprising:
a cylindrical fastening portion for inserting a battery post therein, that includes a fastening aperture dividing a circumferential portion of the cylindrical fastening portion radially, the cylindrical fastening portion including a first extension fastening portion and a second extension fastening portion, the first extension fastening portion extending circumferentially on one end side where the fastening aperture is formed, the second extension fastening portion extending circumferentially on the other end side where the fastening aperture is formed, the first extension fastening portion and the second extension fastening portion being disposed alternately;
a first grip portion that is connected continuously to the first extension fastening portion, the first grip portion including a first through hole that is formed to penetrate the first grip portion in an insertion direction of the battery post; and
a second grip portion that is connected continuously to the second extension fastening portion, the second grip portion including a second through hole that is formed to penetrate the second grip portion in the insertion direction of the battery post, the second through hole overlapping with a part of the first through hole when viewed in the insertion direction of the battery post; and
a fastening unit including a tapered portion whose outer diameter increases gradually from an outer diameter narrower than a region where the first through hole and the second through hole overlap with each other before insertion of the fastening unit to an outer diameter wider than the overlapping region when viewed in the insertion direction of the battery post,
wherein when the fastening unit is inserted into the first through hole and the second insertion hole, the overlapping region is expanded by the tapered portion so that the first extension fastening portion to which the first grip portion is continuously connected and the second extension fastening portion to which the second grip portion is continuously connected are moved to cross each other to thereby narrow the fastening aperture of the cylindrical fastening portion, so that the battery post is fastened by an inner circumferential surface of the cylindrical fastening portion.

2. The battery terminal according to claim 1, wherein the second extension fastening portion has a width as same as that of the first extension fastening portion and is located adjacently to the first extension fastening portion in the insertion direction of the battery post.

3. The battery terminal according to claim 2, wherein the first grip portion includes a first plate grip portion and a first protrusion grip portion, the first plate grip portion having a plate-like shape and connected continuously to an external surface of a side end portion of the first extension fastening portion on the second extension fastening portion side so as to extend in a tangential direction of the first extension fastening portion, the first through hole being formed in the first plate grip portion, the first protrusion grip portion protruding from a longitudinal end portion of the first plate grip portion in a direction perpendicular to a longitudinal direction of the first plate grip portion so as to face a circumferential end portion of the first extension fastening portion; and
wherein the second grip portion includes a second plate grip portion and a second protrusion grip portion, the second plate grip portion having a plate-like shape and connected continuously to an external surface of a side end portion of the second extension fastening portion on the first extension fastening portion side so as to extend in a tangential direction of the second extension fastening portion, the second through hole being formed in the second plate grip portion, the second plate grip portion overlapping with a part of the first plate grip portion, the second protrusion grip portion protruding from a longitudinal end portion of the second plate grip portion in a direction perpendicular to a longitudinal direction of the second grip portion so as to face a circumferential end portion of the second extension fastening portion and the first protrusion grip portion.
